(19) United States
(12) Patent Application Publication
(10) Pub. No.: US 2008/0017219 A1
(43) Pub. Date: Jan. 24, 2008

(54) TRANSDUCER ASSEMBLY INCORPORATING A TRANSMITTER HAVING THROUGH HOLES, AND METHOD AND SYSTEM FOR CLEANING A SUBSTRATE UTILIZING THE SAME

(76) Inventor: Cole Franklin, San Clemente, CA (US)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/777,252

(22) Filed: Jul. 12, 2007

Related U.S. Application Data
(60) Provisional application No. 60/830,254, filed on Jul. 12, 2006.

(51) Int. Cl. B08B 3/12; H04R 1/00

(52) U.S. Cl. 134/1; 134/115 R; 367/189

(57) ABSTRACT

An apparatus, system and method for processing a substrate utilizing sonic energy. In one aspect, the invention utilizes a transmitter having through holes to dampen sonic energy that may damage the substrate. In other aspects, the through holes of the transmitter can be adapted to introduce a liquid solution having bubbles of a controlled size into the meniscus that couples the transmitter to the surface of a substrate to be cleaned to further dampen the sonic energy. IN one embodiment, the invention is a system for processing a substrate comprising: a rotary support for supporting a substrate in a substantially horizontal orientation; a transducer assembly comprising a transmitter and a transducer adapted to generate sonic energy, the transducer acoustically coupled to the transmitter; a plurality of internal passageways extending through the transmitter from holes in a first outer surface of the transmitter to holes in a second outer surface of the transmitter; and the transducer assembly positioned so that so that a portion of the vibration transmitter is adjacent to and spaced from a surface of a substrate on the rotary support so that when a liquid is applied to the surface of the substrate, a film of the liquid couples the portion of the transmitter to the surface of the substrate.

### CROSS-REFERENCE TO RELATED PATENT APPLICATION

The present application claims the benefit of U.S. Provisional Application No. 60/830,254, filed on Jul. 12, 2006, the entirety of which is hereby incorporated by reference.

### FIELD OF THE INVENTION

The present invention relates generally to the field of processing substrates utilizing sonic energy and, specifically, to apparatus, systems and methods for the megasonic-assisted cleaning of substrates that contain delicate devices, such as semiconductor wafers.

### BACKGROUND OF THE INVENTION

In the field of semiconductor manufacturing, it has been recognized since the beginning of the industry that removing particles from semiconductor wafers during the manufacturing process is a critical requirement to producing quality profitable wafers. While many different systems and methods have been developed over the years to remove particles from semiconductor wafers, many of these systems and methods are undesirable because they cause damage to the wafers. Thus, the removal of particles from wafers must be balanced against the amount of damage caused to the wafers by the cleaning method and/or system. It is therefore desirable for a cleaning method or system to be able to break particles free from the delicate semiconductor wafer without resulting in damage to the device structure.

Existing techniques for freeing the particles from the surface of a semiconductor wafer utilize a combination of chemical and mechanical processes. One typical cleaning chemistry used in the art is standard clean 1 (“SC1”), which is a mixture of ammonium hydroxide, hydrogen peroxide, and water. SC1 oxidizes and etches the surface of the wafer. This etching process, known as undercutting, reduces the physical contact area to which the particle binds to the surface, thus facilitating ease of removal. However, a mechanical process is still required to actually remove the particle from the wafer surface.

For larger particles and for larger devices, scrubbers have been used to physically brush the particle off the surface of the wafer. However, as device sizes shrank in size, scrubbers and other forms of physical cleaners became inadequate because their physical contact with the wafers was causing catastrophic damage to smaller devices.

Recently, the application of acoustical/sonic energy to the wafers during chemical processing has replaced physical scrubbing to effectuate particle removal. The sonic energy used in substrate processing is generated via a source of sonic energy. Typically, this source of sonic energy comprises a transducer which is made of piezoelectric crystal. In operation, the transducer is coupled to a power source (i.e. a source of electrical energy). An electrical energy signal (i.e. electricity) is supplied to the transducer. The transducer converts this electrical energy signal into vibrational mechanical energy (i.e. sonic energy) which is then transmitted to the substrate(s) being processed. Characteristics of the electrical energy signal supplied to the transducer from the power source dictate the characteristics of the sonic energy generated by the transducer. For example, increasing the frequency and/or amplitude of the electrical energy signal will increase the frequency and/or amplitude of the sonic energy being generated by the transducer.

Over time, wafer cleaning utilizing sonic energy became the most effective method of particle removal in semiconductor wet process applications. Sonic energy has proven to be an effective way to remove particles, but as with any mechanical process, damage is possible and sonic cleaning is faced with the same damage issues as traditional physical cleaning methods and apparatus. In the past, cleaning systems utilizing sonic energy were designed to process semiconductor wafers in batches, typically cleaning twenty-five substrates at once. The benefits of batch cleaning became less important as the size of substrates and the effectiveness of single-wafer cleaning systems increased. The greater value per semiconductor wafer and the more delicate nature of the devices resulted in a transition in the industry toward single-wafer processing equipment.

An example of a single-wafer cleaning system that utilizes megasonic energy is disclosed in U.S. Pat. No. 6,039,059 (“Bran”), issued Mar. 21, 2000, and U.S. Pat. No. 7,100,304 (“Lauerhaas et al.”), issued Sep. 5, 2006, the entireties of which are hereby incorporated by reference herein. The single-wafer cleaning system that is the subject of U.S. Pat. No. 6,039,059 and U.S. Pat. No. 7,1003,304 is commercialized by Akrion, Inc. of Allentown, Pa. under the name “Goldfinger®.” Other examples of single-wafer cleaners that utilize acoustic energy are disclosed in U.S. Pat. No. 7,145,286 (“Beck et al.”), issued Dec. 5, 2006, U.S. Pat. No. 6,539,952 (“Itzkowitz”), issued Apr. 1, 2003, and U.S. Patent Application Publication 2006/0278253 (“Verhaverbeke et al.”), published Dec. 14, 2006. In single-wafer sonic cleaning systems, such as the ones mentioned above, a semiconductor wafer is supported and rotated in horizontal orientation while a film of liquid is applied to one or both sides/surfaces of the wafer. A transducer assembly is positioned adjacent to one of the surfaces of the wafer so that a transmitter portion of the transducer assembly is in contact with the film of liquid by a meniscus of the liquid. The transducer assembly is activated during the rotation of the wafer, thereby subjecting the wafer to the sonic energy generated by the transducer assembly.

Nonetheless, the industry's transition to the below 100 nm devices has resulted in additional challenges for manufacturers of semiconductor processing equipment. The cleaning process is no different. As a result of the devices becoming more and more miniaturized, cleanliness requirements have also become increasingly important and stringent. When dealing with reduced size devices, the ratio of the size of a contaminant compared to the size of a device is greater, resulting in an increased likelihood that a contaminated device will not function properly. Thus, increasingly stringent cleanliness and PRE requirements are needed. As a result, improved semiconductor wafer processing techniques that reduce the amount and size of the contaminants present during wafer production are highly desired.

Despite these advancements in single-wafer systems and methods for cleaning wafers, there still remains a need for single-wafer systems that can achieve improved PRE with minimized device damage. Furthermore, the continued miniaturization of devices continues to render existing cleaning systems in capable of achieving an acceptable balance between high PRE and minimized device damage.

To improve cleaning and to reduce damage caused by wafers by the application of megasonic energy, megasonic suppliers have implemented solutions that control the frequency of the sonic energy, the amplitude of the sonic energy, and the angles at which the sonic energy is applied to the wafers. However, even with these controls, damage is still occurring.

Existing transmitter designs, such as those shown in FIGS. 1A and 1B, have been discovered to have problems with damaging certain areas of the substrate during the cleaning procedure. FIGS. 1A and 1B schematically illustrate the two major types of damage that have been discovered to occur with the existing transmitter designs. FIG. 1A illustrates how the existing transmitter design has a tendency to damage the center area of the rotating wafer. Damage to the central portion of the wafer 10 is though to be the result of sonic energy passing through the tip 13 of the transmitter 12, which then passes through a non-uniform fluid meniscus 15 and contacts the wafer surface. The sonic energy is not dampened sufficiently when transmitted through the thinner portion of the meniscus 15. FIG. 1B illustrates the second area of noted damage on the wafers, the edge region. Damage to the edge region is believed to be caused by the critical distribution of sonic energy at the boundary between the air 17 and the meniscus 15. At this boundary, the sonic energy is not sufficiently dampened and/or is reflected back into the wafer, thereby causing damage to the devices in this region.

Therefore a need exists for an improved apparatus, system and method for cleaning semiconductor wafers that is able to achieve a high PRE while minimizing damage to the delicate devices on the wafer.

### SUMMARY OF THE INVENTION

An object of the present invention is to provide an apparatus, system and method that is able to dampen sonic energy during a substrate cleaning process.

Another object of the present invention is to provide an apparatus, system and method that can achieve high PRE while minimizing damage to the substrate.

Yet another object of the present invention is to provide an apparatus, system and method that provides a novel way of introducing a processing fluid to the meniscus of liquid that couples a transducer assembly to the substrate surface.

Still another object of the present invention is to provide an apparatus, system and method that provides cost savings by reducing the amount of DI water required in a cleaning process.

These and other objects are met by the present invention, which in one aspect can be a system for processing a substrate comprising: a rotary support for supporting a substrate in a substantially horizontal orientation; a transducer assembly comprising a transmitter and a transducer adapted to generate sonic energy, the transducer acoustically coupled to the transmitter; a plurality of internal passageways extending through the transmitter from holes in a first outer surface of the transmitter to holes in a second outer surface of the transmitter; and the transducer assembly positioned so that so that a portion of the vibration transmitter is adjusted to and spaced from a surface of a substrate on the rotary support so that when a liquid is applied to the surface of the substrate, a film of the liquid couples the portion of the transmitter to the surface of the substrate.

In another aspect, the invention can be a system for processing a substrate comprising: a rotary support for supporting a substrate in a substantially horizontal orientation; a transducer assembly comprising a transmitter and a transducer adapted to generate sonic energy, the transducer acoustically coupled to the transmitter; the transducer assembly positioned so that so that a portion of the vibration transmitter is adjacent to and spaced from a surface of a substrate on the rotary support so that when a liquid is applied to the surface of the substrate, a film of the liquid couples the portion of the transmitter to the surface of the substrate; a plurality of holes in the portion of the transmitter, the holes extending into the transmitter as internal passageways that are adapted to be operably connected to a source of fluid.

In yet another aspect, the invention can be a system for processing substrates comprising: a rotary support for supporting a substrate; a transducer assembly comprising a transmitter and a transducer adapted to generate sonic energy, the transducer acoustically coupled to the transmitter; the transducer assembly positioned so that so that a portion of the vibration transmitter is adjacent to and spaced from a surface of a substrate on the rotary support so that when a liquid is applied to the surface of the substrate, a film of the liquid couples the portion of the transmitter to the surface of the substrate; a plurality of holes in an outer surface of the transmitter, the holes extending into the transmitter as internal passageways that are adapted to be operably connected to a source of fluid.

In a further aspect, the invention can be a transducer assembly comprising: a transducer adapted to generate sonic energy; a transmitter, the transducer acoustically coupled to the transmitter; a plurality of holes in an outer surface of the transmitter, the holes extending into the transmitter as internal passageways that are adapted to be operably connected to a source of fluid.

In a yet further aspect, the invention can be a transducer assembly comprising: a transducer adapted to generate sonic energy; a transmitter, the transducer acoustically coupled to the transmitter; and a plurality of internal passageways extending through the transmitter from holes in a first outer surface of the transmitter to holes in a second outer surface of the transmitter.

In a still further aspect, the invention can be a method of processing a substrate comprising: supporting a substrate in a substantially horizontal orientation; rotating the substrate; providing a transducer assembly comprising a transducer adapted to generate sonic energy and a transmitter, the transducer acoustically coupled to the transmitter, and a plurality of holes in an outer surface of the transmitter, the holes extending into the transmitter as internal passageways that are adapted to supply a fluid; applying a liquid to a surface of the substrate so as to form a meniscus of the liquid that couples a portion of the transmitter to the surface of the substrate; applying sonic energy to the surface of the substrate via the transmitter; and applying fluid into the meniscus via the holes in the outer surface of the transmitter.

In another aspect, the invention can be a method of processing a substrate comprising: a) supporting a substrate in a substantially horizontal orientation; b) rotating the substrate; c) providing a transducer assembly comprising a transmitter and a transducer adapted to generate sonic energy having a frequency, the transducer acoustically coupled to the transmitter; d) applying sonic energy to the surface of the substrate via the transmitter, the sonic energy having a field; and e) applying a liquid with bubbles to the surface of the substrate in the sonic energy field so that the bubbles dampen the sonic energy reaching the surface of the substrate, the bubbles having a predetermined size correlating to the frequency of the sonic energy.

In still another aspect, the invention can be a system for processing a substrate comprising: a rotary support for supporting a substrate; a transducer assembly comprising a transmitter and a transducer adapted to generate sonic energy, the transducer acoustically coupled to the transmitter; the transducer assembly positioned so that so that a portion of the vibration transmitter is adjacent to and spaced from a surface of a substrate on the rotary support so that when a liquid is applied to the surface of the substrate, a film of the liquid couples the portion of the transmitter to the surface of the substrate; a plurality of holes in an outer surface of the transmitter, the holes extending into the transmitter as internal passageways that are adapted to be operably connected to a source of a solution comprising bubbles having a predetermined size.

### BRIEF DESCRIPTION OF THE DRAWING(S)

FIG. 1a is a diagram of a prior art system showing the cause of center damage.

FIG. 1b is a depiction of a prior art system showing the cause of edge damage.

FIG. 2 is a side elevational view of a system in which the transducer assembly of the present invention can be used.

FIG. 3 is a side cross-sectional view of the transducer assembly shown in FIG. 2.

FIG. 4a shows a transmitter having a plurality of through holes in accordance with an embodiment of the present invention.

FIG. 4b shows a cross-sectional view of a transmitter positioned over a substrate, in accordance with the embodiment of the invention shown in FIG. 4a.

FIG. 5a shows a transmitter in accordance with another embodiment of the present invention.

FIG. 5b shows a transmitter in accordance with yet another embodiment of the present invention

FIG. 5c shows a transmitter in accordance with another embodiment of the present invention.

FIG. 5d shows a transmitter in accordance with yet another embodiment of the present invention.

FIG. 6 shows a diagram of a system using a transmitter with through holes, in accordance with the embodiment of the present invention shown in FIGS. 4a and 4b.

FIG. 7a is a side view of a transmitter in accordance with yet another embodiment of the present invention.

FIG. 7b is a cross-sectional view of another embodiment of the transmitter taken along the line drawn from I-II of the transmitter shown in FIG. 7a.

FIG. 7c is a side view of a transmitter shown positioned over a substrate, in accordance with the embodiment of the present invention shown in FIGS. 7a-7b.

FIG. 8 is a diagram of the system for cleaning substrates using the transmitter shown in FIGS. 7a-7c.

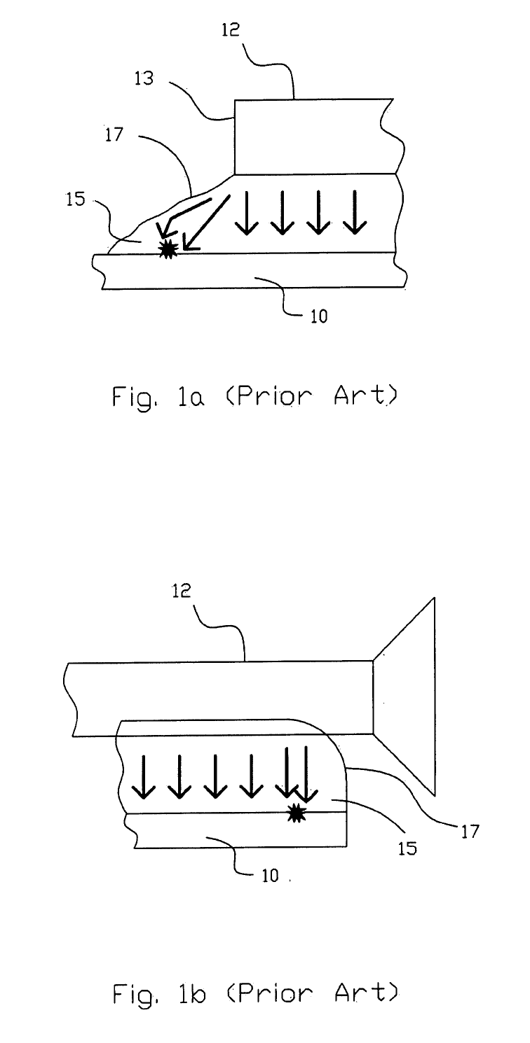

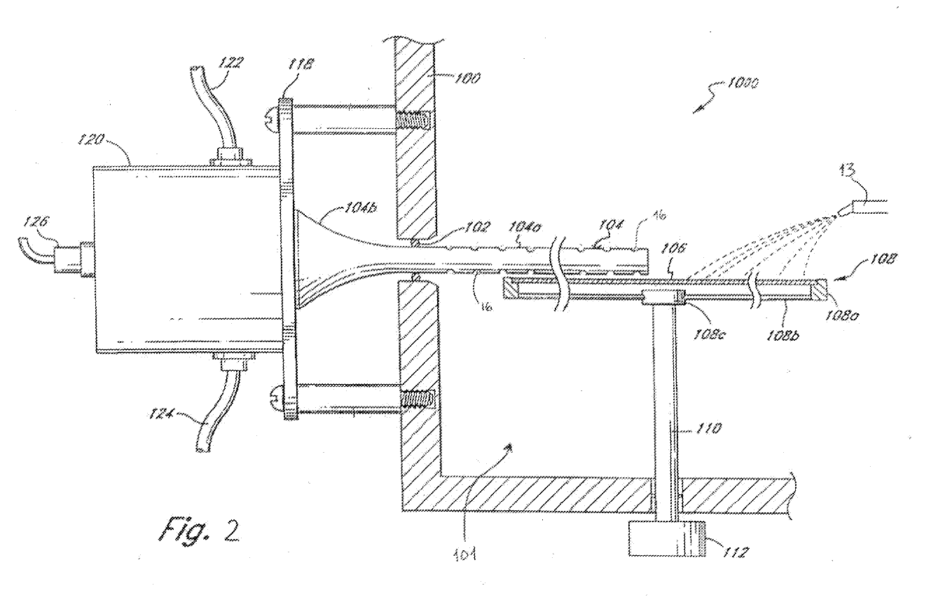

### DETAILED DESCRIPTION OF THE INVENTION

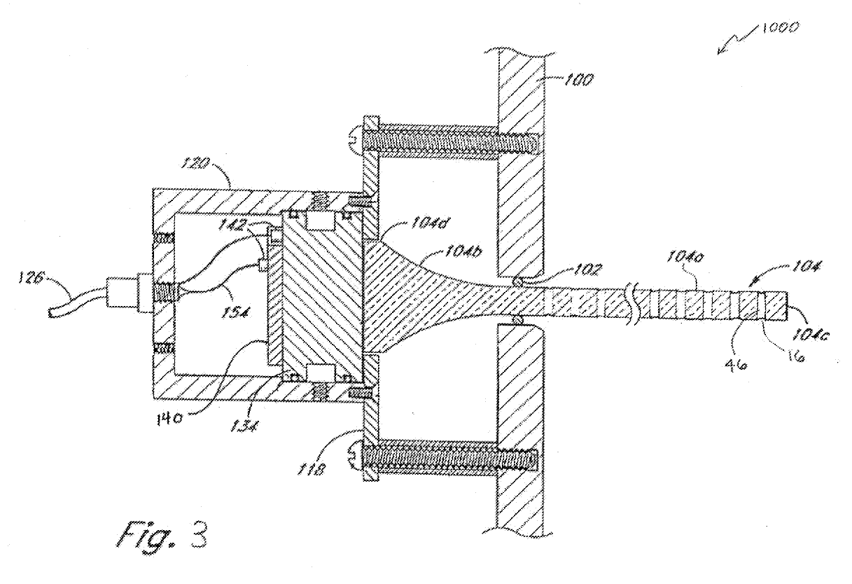

Referring first to FIGS. 2 and 3 concurrently, a side elevation view of an exemplary megasonic energy cleaning system 1000 (hereinafter referred to as the “cleaning system 1000”) is illustrated according to one embodiment of the present invention. For ease of discussion, the inventive system and methods of the drawings will be discussed in relation to the cleaning of substrates. It is to be understood that the invention can be utilized for any desired wet processing of any flat article, including without limitation semiconductor wafers.

The cleaning system 1000 has an elongated transmitter 104 inserted through the wall 100 of a processing tank 101. The transmitter 104 is supported in a cantilever fashion at one exterior end of the processing tank 101. An O-ring 102 is sandwiched between the transmitter 104 and the wall 100 to act as a seal for the processing tank 101. The transmitter 104 is acoustically coupled to a transducer 140 adapted to generate sonic energy. More specifically, in the illustrated embodiment, a heat transfer member 134, is contained within a housing 120, and is acoustically and mechanically coupled to the transmitter 104. Also contained within the housing 120 is a piezoelectric transducer 140 acoustically coupled to the heat transfer member 134. Electrical connectors 142, 154, and 126 are connected between transducer 140 and a source of acoustic energy (not shown).

The housing 120 has inlet conduit 124 and outlet conduit 122 running to and from it for coolant and further has an opening for electrical connectors. The housing 120 is closed at one end by an annular plate 118. The annular plate having an opening for the transmitter 104. The annular plate 118 is in turn attached to the processing tank 101.

Within the processing tank 101, a support 108 is positioned parallel to and in close proximity to the transmitter 104. The support 108 is a rotatable support for supporting a substrate 106 in a substantially horizontal orientation. In the arrangement illustrated, the outer rim 108a is supported by a plurality of spokes 108b and connected to the hub 108c supported on shaft 110. The exact details of the structure of the support 108, however, are not limiting of the present invention and a wide variety of support structures can be used, such as chucks, support plates, etc. The shaft 110 extends through a bottom wall of the processing tank 101. Located outside of the processing tank 101, the shaft 110 is connected to the motor 112.

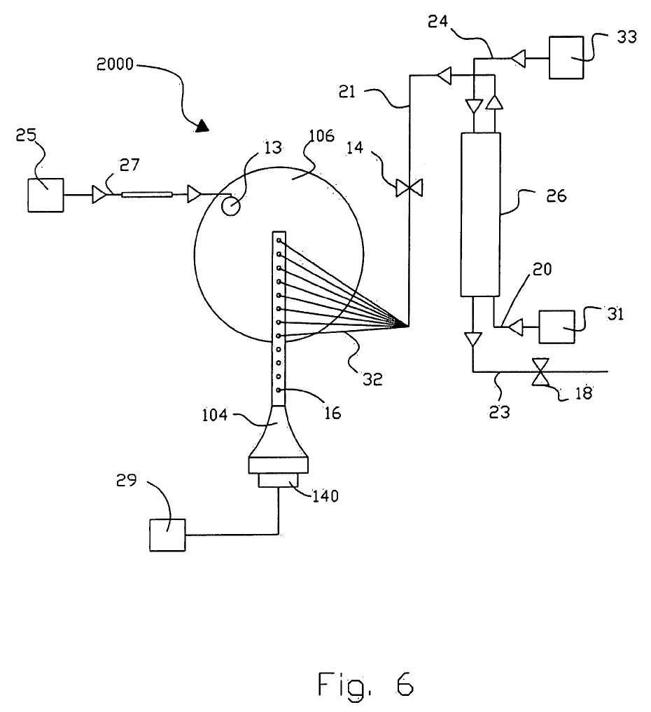

The cleaning system 1000 further comprises a top dispenser 13 for supplying liquid to the substrate. The top dispenser 13 is operably and fluidly coupled to a liquid supply system via liquid supply lines (shown in FIG. 6). The liquid supply system is in turn fluidly connected to a liquid reservoir 25 (shown in FIG. 6). The liquid reservoir 25 holds the desired liquid to be supplied to the substrate 106 for the processing that is to be carried out.

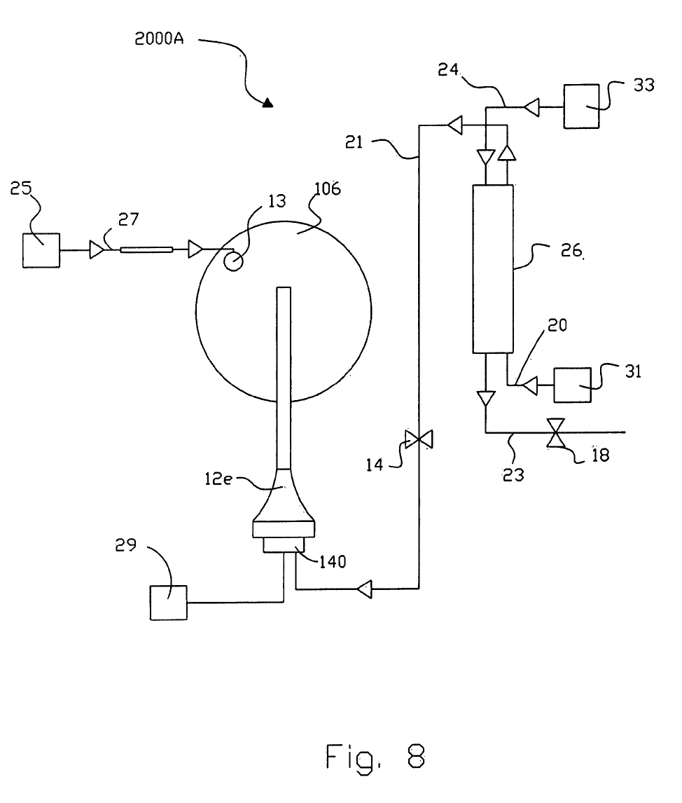

For cleaning system 1000, the liquid reservoir 25 will hold a cleaning liquid, such as for example deionized water (“DIW”), standard clean 1 (“SC1”), standard clean 2 (“SC2”), ozonated deionized water (“DIO₃”), dilute or ultra-dilute chemicals, and/or combinations thereof. As used herein, the term “liquid” includes at least liquids, liquid-liquid mixtures and liquid-gas mixtures. It is also possible for certain other supercritical and/or dense fluids to qualify as liquids in certain situations. Furthermore, it is possible to have multiple liquid reservoirs. For example, in some embodiments of the invention, a second dispenser 32 (shown in FIGS. 6 and 8) can be operably and fluidly coupled to different reservoirs to supply liquid through the transmitter 104. As will be discussed in more detail below, this would allow the application of different liquids to different areas of the substrate 106 for more effective cleaning.

When in the processing position, at least a portion of the transmitter 104 is spaced from but sufficiently close to the top surface of the substrate 106 so that when liquid is supplied to the top surface of the substrate 106 via the dispenser 13, a film of liquid is formed between the top surface of the substrate 106 and that portion of the transmitter 104. The film of liquid may be a meniscus of liquid that couples a portion of the transmitter 104 to the surface of the substrate 106. In FIGS. 2-3, the transmitter 104 is in the processing position.

The transducer 140 is made of a piezoelectric material so as to be capable of electrical excitation. Electrical excitation causes the transducer 140 to vibrate and subsequently causes the transmitter 104 to vibrate so as to transmit sonic energy to the meniscus that covers the substrate 106. The transmission of sonic energy through the meniscus facilitates the cleaning of the substrate 106.

In the cleaning system 1000, the elongated transmitter 104 is preferably made of a relatively inert, non-contaminating material, such as quartz, which efficiently transmits acoustic energy. While utilizing a quartz transmitter is satisfactory for most cleaning solutions, solutions containing hydrofluoric acid can etch quartz. Thus, a transmitter made of sapphire or silicon carbide or boron nitride may be employed instead of quartz. Also, a transmitter made of quartz may be coated with a material that can withstand HF such as silicon carbide or vitreous carbon.

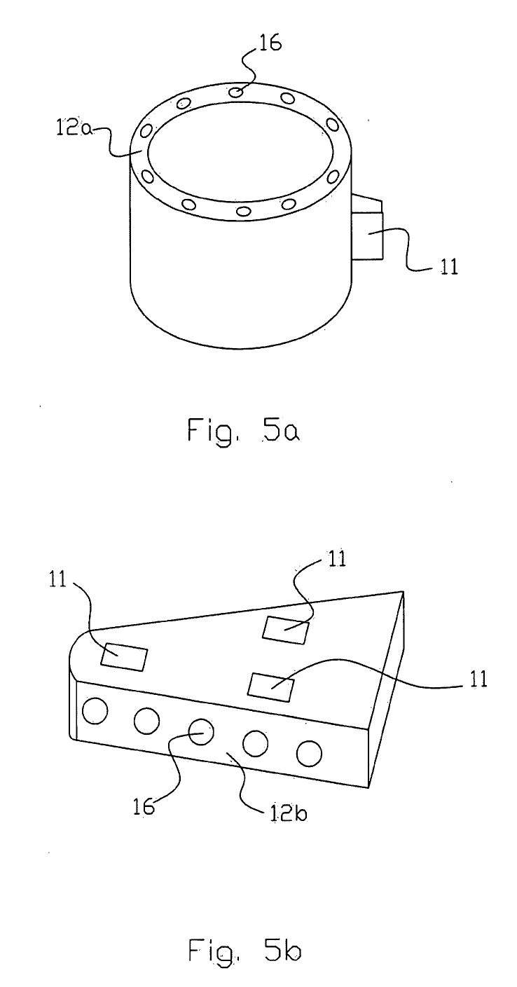

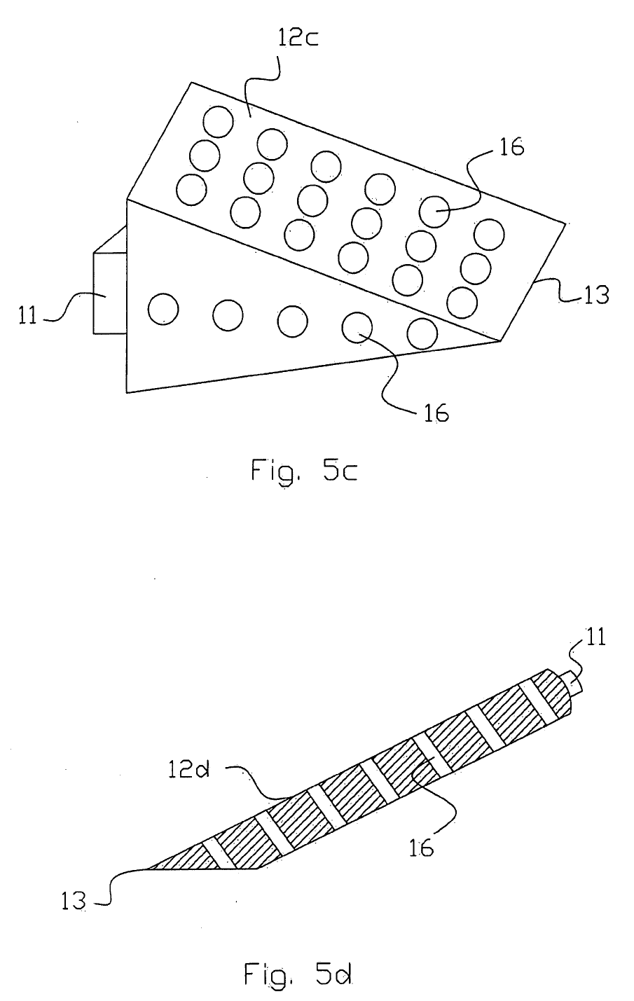

The transmitter 104 is a rod-like object comprising an elongated cleaning portion 104a, and a rear portion 104b. The cross-section of the transmitter 104 is circular. As discussed in more detail with respect to FIGS. 5a-5d, however, cross-sectional shapes other than circular may be employed. Additionally, more than one transmitter 104 may be used. The diameter of the cleaning portion 104a of the transmitter 104 is smaller in diameter than the rear portion 104b of the transmitter 104, and the area of the rear face of the rear portion 104b is larger than that of the tip face of portion 104a. A cylindrically-shaped cleaning section 104a having a small diameter is desirable because it concentrate the megasonic energy along the length of the section 104a. The diameter of the cross-section of the rear portion of the transmitter gradually increases to a cylindrical section 104d. The large surface area at the end of the rear portion 104d is advantageous for transmitting a large amount of megasonic energy which is then concentrated in the smaller diameter section 104a. The cross-section diameter of the cylindrical portion of the transmitter 104 contained within the tank is approximately between 0.1 to 0.9 of an inch. The invention is not so limited, but the diameter of the transmitter should be sufficient to withstand mechanical vibration produced by the megasonic energy transmitted by the transducer 140.

The transmitter cleaning portion 104a should be long enough so that the entire surface area of the substrate 106 is exposed to the transmitter during cleaning. Because the substrate 106 is rotated beneath the transmitter 104, the length of the cleaning portion 104b should be long enough to reach at least the center of the substrate. Therefore, as the substrate 106 is rotated beneath the transmitter 104, the entire surface area of the substrate 106 is close to the transmitter 104. The transmitter 104 can also function satisfactorily even if it does not reach the center of the substrate 106 since megasonic vibration from the transmitter tip 104c provides some agitation towards the center of the substrate 106. The length of the transmitter may also be determined by a predetermined number of wavelengths.

The transmitter 104 further comprises a plurality of holes 16. As will be discussed in further detail, the holes 16 assist, among other things, in preventing both edge and center damage to the substrate 106. Additionally, the cleaning of the substrate 106 can be increased while at low powers via the usage of holes 16 in transmitter 104. One way of controlling the cleaning of the substrate 106 is by creating sonic energy having a power density that is less than 12.5 watts per cm². Having a power density less than this amount reduces the potential for damage to the substrate 106. The power density is based on the area of the first surface of the substrate 106. The power density is preferably within the range of 0.01 to 12.5 watts per cm². And more preferably within the range of 0.01 to 4 Watts per cm², and even more preferably within the range of 1 to 4 watts per cm². The power is applied within a predetermined time that is within the range of 20 to 70 seconds. The predetermined time and power density are selected so as to remove at least 80% of particles from the first surface of the substrate. In one process, the time used was approximately 30 seconds and the power density was approximately 0.2 watts/cm2. Using this process approximately 80% of the particles were removed from the surface of the substrate 106. In this example, the cleaning fluid used was an ambient standard clean 1 (SC1) solution. The sonic energy used in this example was within the range of 800 kHz to 2 MHz.

Referring still to FIGS. 2 and 3, the size of holes 16 relative to the size of the transmitter 104 is exaggerated in the illustration for purposes of visual clarity. The relative size between the transmitter and the holes in reality is not the same as the relative size in the illustration. The holes 16 may have a diameter in the range of 0.1 μm and 5.0μ. In the embodiment shown, the holes 16 form internal passageways 46 that extend through the transmitter 104 from a first surface of the transmitter 104 to a second surface of the transmitter 104. Of course, an interpretation of a curved and/or circular object, like transmitter 104, is that there is only one continuous surface. As used herein, however, separate segments of a curve are considered separate surfaces. Thus, the first surface of the transmitter 104 is a bottom segment of the transmitter positioned nearest the substrate 106 and the second surface of the transmitter 104 is a top segment of the transmitter positioned furthest from the substrate. The invention, is not so limited however, and as will be discussed in alternative embodiments of the invention, it is not necessary that the internal passageways extend through the transmitter in the above manner.

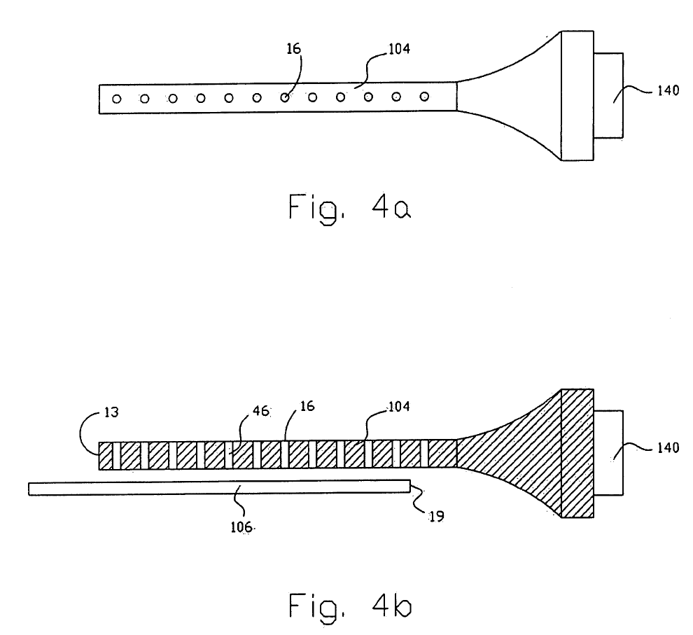

FIG. 4a is a top view of an embodiment of the transmitter 104 in accordance with an embodiment of the present invention. The holes 16 are arranged in a linear fashion along a horizontal axis that runs through the center of the transmitter 104. It is also possible, however, that the holes 16 can be arranged in various geometric formations along the surface of the transmitter 104. The holes 16 may be used as openings to receive and/or deliver fluids through a passageway to the surface of the substrate 104. The fluids may include sonicated liquid, in some embodiments. Usage of the holes 16 may remove the need for DI water dampening of the transmitter 104 and thereby increase overall water savings during a cleaning process.

FIG. 4b shows the transmitter 104 in cutaway view positioned over the substrate 106. The transmitter 104 is positioned over the substrate 106 in such a way that the holes 16 are positioned both over substrate 106 and before the edge 19 of the substrate 106. In some embodiments, the holes 16 are positioned only on the portion of the transmitter 104 that is positioned over the substrate. The passageways 46 extend from the holes 16 located along one surface of the transmitter 104 and the holes 16 located at a second surface of the transmitter 104. The holes 16, may conceptually be considered as extending into the transmitter 104 as passageways, are substantially vertically oriented, linear passageways running parallel with each other. The passageways 46 may have a diameter in the range of between 1 μm and 5.0 μm that is constant along their full height. The invention is not so limited however and the passageways 46 may be inclined at various angles and/or diverging. The passageways 46 may also be of varying diameter along their height. The passageways 46 extend from the bottom surface of the transmitter 104 through the top surface of the transmitter 104. The invention is not so limited however, and the passageways 46 may extend into the transmitter but are not required to pass through the transmitter in a linear fashion. It is also possible for the passageways to not be parallel with each other. The holes 16 may be considered passageways

The sonic energy generated by the transducer 140, in this embodiment, is transmitted through the transmitter 104 along a transmission path that runs the length of the transmitter 104 along its horizontal axis. The passageways 46 pass transversely through the transmission path. Thus, the energy generated by the transducer 140 must pass through the gaps created by the passageways 46, and in doing so the energy is dampened. Therefore, the passageways 46 assist in dampening the megasonic energy that is provided to the substrate 106 through the meniscus of cleaning fluid.

FIGS. 5a-5d illustrate alternative embodiments of transducer assemblies that use different shaped configurations of transmitters 12a-d. FIG. 5a illustrates a transmitter 12a that is cylindrical in shape. The holes 16 may pass through the bottom of the transmitter 12a. FIG. 5b shows a transmitter 12b that is wedge shaped. The transmitter 12b has attached to it three transducers 11, however as noted above more than three transducers 11 may be used. Each of the transducers 11 are electrically connected so as to enable the transmitter 12b to vibrate. The holes 16 may pass through one side to the other side of transmitter 12b. FIG. 5c shows a wedge shaped transmitter 12c. The transmitter 12c may also have holes 16 from a first side to a second side, through the top surface to the bottom surface, and/or alternatively from the side to either the top or bottom surface. FIG. 5d shows a cross-section of a conical shaped transmitter 12d that has a tapered tip 13 having holes 16. These various embodiments all benefit from the usage of holes 16 in order to prevent damage to the substrate during cleaning. The various shapes of the transmitters affect how the megasonic energy is transmitted during the cleaning process.

FIG. 6 shows a diagram of a cleaning system 2000 comprising a fluid supply system, which is schematically illustrated as boxes and lines for purposes of simplicity, and which comprises the desired arrangement of all of the necessary pumps, valves, ducts, connectors and sensors for controlling the flow and transmission of the gases, liquids and/or combinations thereof, throughout the cleaning system 2000. The direction of the fluid flow is represented by the arrows on the supply lines 20, 21, 23, 24, 27. Those skilled in the art will recognize that the, existence, placement and functioning of the various components of the fluid supply system will vary depending upon the needs of the cleaning system 2000 and the processes desired to be carried out thereon, and can be adjusted accordingly. Furthermore, all of the components are operably connected to and controlled by a system controller (not shown). The controller controls and regulates the flow of fluid for the substrate processing system through operable and electrical connections to the pumps, valves, sensors, etc. The controller can communicate with the various components of the liquid sources and/or gas sources in order to automatically adjust and maintain process conditions, such as the temperature of the fluid, flow rates, etc.

The system 2000 is substantially similar to the system 1000 discussed above. The system 2000 uses the rod like transmitter 104 with holes 16 in accordance with an embodiment of the present invention. A transducer 140, adapted to generate sonic energy, is acoustically coupled to the transmitter 104. The transducer 140 is connected to an energy source 29 so as to be able to receive electrical excitation. The substrate 106 is positioned on a support member (not shown) which in turn is operably connected to a motor (not shown) that when activated rotates the substrate 106. The transmitter 104 with holes 16 is positioned above the substrate 106 having an edge 19.

Also provided in the system 2000 is first fluid line 27, that is operably and fluidly connected to a first fluid source 25. The first fluid source 25 may store liquids, gases, and/or vapors, which can be any one of the standard cleaning chemicals used in the processing of substrates. A cleaning chemical used is sent through the fluid lines 27 which is also fluidly connected to the dispenser 13 that can effectively transmit the cleaning chemical to the surface of the substrate 106 thereby forming a meniscus of liquid during substrate processing.

The system 2000 further comprises a second fluid line 20, that is operably connected to a second fluid source 31, and a gas line 24 that is operably and fluidly connected to a gas source 33. The fluid used with the second fluid source 31 is a cleaning fluid not limited to any specific gas, fluid or combination thereof. Examples of suitable cleaning fluids include, but are not limited to, deionized water, diluted hydrofluoric acid, hydrochloric acid, hydrogen peroxide, ammonia hydroxide, ammonia, Standard Clean 1 (ammonia hydroxide/hydrogen peroxide/deionized water), Standard Clean 2 (hydrochloric acid/hydrogen peroxide/deionized water), RCA solutions, dilute acids, dilute bases or semi-aqueous solvents, and RCA cleaning liquids, any combination thereof or the like. Used herein, the term fluid may encompass liquids, gases, and vapors. The exact fluid and/or gas used will depend on the cleaning process being performed, the type of substrate being processed, the size of the devices on the substrate, and the susceptibility of the devices to damage. The gas in the gas source 31, is not limited to any specific gas, fluid or combination thereof. Examples of suitable gases include, without limitation, NH₃, N₂, O₂, He, Ar, air, CO₂, O₃ and the like. The gas can be any reactive gas, non-reactive gas, or combination thereof. Used herein, the term gas is also intended to include the gaseous state of a substance which under ambient or ordinary conditions exists as a liquid or solid, i.e., vapor. In the embodiment shown in FIG. 6, the gas being used is CO₂. The gas output line 22 has a gas regulator 18 which outputs the gas out at between 0.5 to 3.0 bars. In some embodiments, a gas may not be added to the fluid. In other embodiments, the fluid supply system can be adapted to mix multiple fluids for supply to the substrate as a fluid mixture.

System 2000 further comprises a mixing chamber 26 and a depressor regulator 14. The mixing chamber 26 and the depressor regulator are designed to utilize Henry's law to create a solution of bubbles in the liquid mixture. The gas line 24 and the second fluid line 20 enter the mixing chamber 26. The gas flowing through the gas line 24 is mixed with liquid flowing through the second fluid line 20. In the mixing chamber 26, gas saturation levels of 1-2 times normal saturation can be achieved. In one embodiment, the applied pressure is preferably 4 bars. Different pressures may be used, however, depending on the desired saturation level of the gas in the liquid. After the liquid and gas is mixed, the solution flows through the liquid supply line 21 and past the depressor regulator 14. The solution is then depressurized by the depressor regulator 14. In one embodiment, the liquid is depressurized to about 1.4 bars. The depressurization in this embodiment creates bubbles in the solution that have a diameter between 0.1 μm to 5.0 μm. It should be understood that the level of pressure to which the solution is depressurized may vary depending upon the solution. The created bubbles have a lifetime that is in the millisecond range. It should also be noted that the bubbles are designed to be of a size that correlates to the frequency of the sonic energy applied through the transmitter 104. The frequency of the sonic energy may be in the range of 600 kHz to 1100 kHz.

The liquid supply line 21 is connected to a dispenser 32 which operably connects the liquid supply line 21 to the holes 16 in the transmitter 104. After being depressurized, the solution (including the bubbles) is dispensed into the transmitter 104 in the following manner. The solution enters the passageways 46 of the transmitter 104 through the holes 16 at the top surface of the transmitter 104. The passageways 46 act to, in part, control the size of the bubbles. The solution is then dispensed onto the substrate 106 through the holes 16 at the bottom surface of the transmitter 104. Thus, the bubbles are inserted directly into the megasonic transmission field without disturbing the meniscus of cleaning fluid that is created by process fluid dispenser 13. The bubbles operate to, among other benefits, reduce the magnitude of megasonic energy produced at the tip of the transmitter 104 by orders of magnitude which reduces damage to the substrate.

The manner in which the solution enters the holes 16 of the transmitter 104 can be any method available in the art, including without limitations, tubes connected directly to the holes 16, fluid being dispensed above the transmitter so that fluid flows into the holes 16, and the like. This process increases the cleaning efficiency for removal of particles that are roughly between 10 to 50 nm in diameter. It has been found that by using applied powers within the range of 1 to 30 dB for the sound fields the damage to nanostructures on the substrate 106 can be controlled.

One of the benefits this method of application of the liquid has over current techniques is that by sending the bubbles into the megasonic field using the transmitter 104, the lifetime of the bubbles is extended. Therefore the application of bubbles of optimum size for the specific frequency is maximized by sending the liquid onto the substrate 106 using the transmitter 104. Sending the solution onto the surface of the substrate 106 and applying the transmitter 104 permits the application of old techniques in order to control the meniscus and deliver the optimum number of bubbles to the sound field.

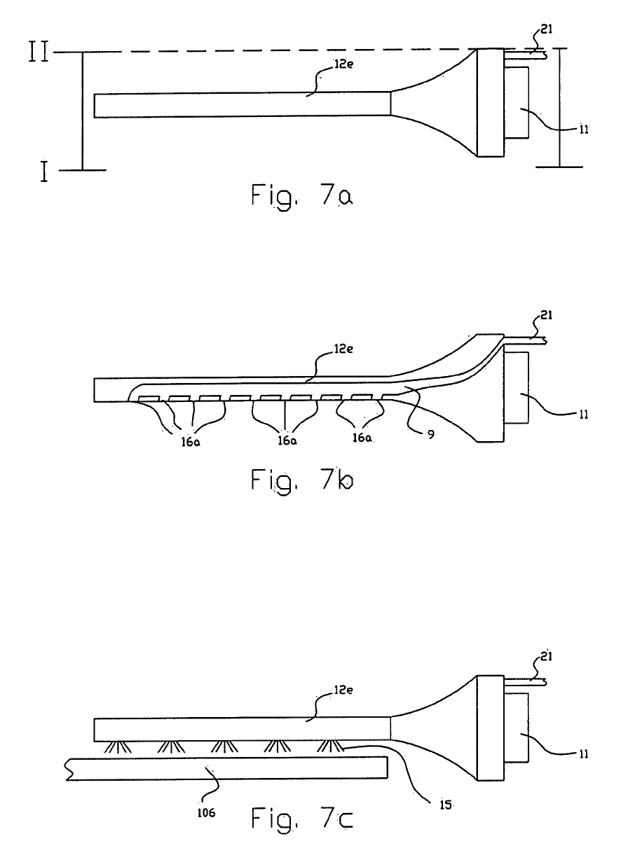

FIG. 7a shows a side view of a transmitter 12e, according to an alternative embodiment of the present invention. The transmitter 12e has a liquid supply line 21 that provides cleaning fluid to the interior of the transmitter 12e. FIG. 7b shows a cross-sectional view of the transmitter 12e taken along the line drawn from I-II showing a passageway 9 running along the length of the transmitter 12e. The holes 16a branch from the passageway 9 and enable the cleaning fluid to be dispersed to the substrate 106. The holes 16e are positioned in the outer surface of the transmitter 12e, the outer surface being a bottom segment of the transmitter 12e that is positioned nearest to the substrate 106. The holes 16e extend into the transmitter 12e and form the passageway 9 that is adapted to receive the solution (with the bubbles) from the liquid supply line 21. FIG. 7c shows a side view of the transmitter 12e positioned over the substrate 106. The fluid meniscus 15 is formed over the substrate 106 and megasonic energy is transmitted through the meniscus 15 via the transmitter 12e. FIG. 8 shows a diagram of a second embodiment of the system 2000 for cleaning substrates using the transmitter 12e. In the system as shown the cleaning liquid is passed directly through the transmitter 12e.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A system for processing a substrate comprising:
a rotary support for supporting a substrate in a substantially horizontal orientation;
a transducer assembly comprising a transmitter and a transducer adapted to generate sonic energy, the transducer acoustically coupled to the transmitter;
a plurality of internal passageways extending through the transmitter from holes in a first outer surface of the transmitter to holes in a second outer surface of the transmitter; and
the transducer assembly positioned so that so that a portion of the vibration transmitter is adjacent to and spaced from a surface of a substrate on the rotary support so that when a liquid is applied to the surface of the substrate, a film of the liquid couples the portion of the transmitter to the surface of the substrate.

2. The system of claim 1 wherein the sonic energy generated by the transducer is transmitted through the transmitter along a transmission path; and wherein the internal passageways pass transversely through the transmission path.

3. The system of claim 1 wherein the transmitter is constructed of quartz or sapphire.

4. The system of claim 1 wherein the portion of the transmitter comprises the holes in the second outer surface.

5. The system of claim 4 further comprising a source of a fluid operably connected to the holes in the first outer surface so that the fluid can be supplied through the passageways.

6. The system of claim 5 wherein the fluid comprises a liquid and a dissolved gas.

7. The system of claim 6 wherein the fluid comprises bubbles, the bubbles having a size between 0.3 μm to 3.0 μm in diameter.

8. The system of claim 1 further comprising:
the transmitter being an elongated transmitter having an axis, the transducer acoustically coupled to the transmitter so that sonic energy is transmitted through the transmitter along the axis; and
the internal passageways passing transversely through the axis.

9. The system of claim 8 wherein the elongated transmitter is a rod-like transmitter.

10. The system of claim 1 wherein the internal passageways are substantially linear.

11. The system of claim 10 wherein the internal passageways are substantially parallel to one another.

12. The system of claim 1 wherein the internal passageways have a diameter in the range between 0.1 μm to 5.0 μm.

13. The system of claim 1 further comprising:
a dispenser operably connected to a source of the liquid, the dispenser positioned to apply the film of the liquid on the substrate;
a source of a fluid comprising a liquid and a gas, the fluid comprising bubbles; and
the source of the fluid operably connected to the holes in the first surface of the transmitter.

14. A system for processing a substrate comprising:
a rotary support for supporting a substrate in a substantially horizontal orientation;
a transducer assembly comprising a transmitter and a transducer adapted to generate sonic energy, the transducer acoustically coupled to the transmitter;
the transducer assembly positioned so that so that a portion of the vibration transmitter is adjacent to and spaced from a surface of a substrate on the rotary support so that when a liquid is applied to the surface of the substrate, a film of the liquid couples the portion of the transmitter to the surface of the substrate;
a plurality of holes in the portion of the transmitter, the holes extending into the transmitter as internal passageways that are adapted to be operably connected to a source of fluid.

15. The system of claim 14 further comprising a dispenser operably connected to a source of the liquid, the dispenser positioned to apply the film of the liquid on the substrate.

16. The system of claim 14 further comprising a source of the fluid operably connected to the internal passageways.

17. The system of claim 16 wherein the fluid comprises a liquid and a dissolved gas.

18. The system of claim 17 wherein the fluid comprises bubbles having a size between 0.3 μm to 3.0 μm in diameter.

19. The system of claim 14 wherein the sonic energy generated by the transducer is transmitted through the transmitter along a transmission path; and wherein the holes extend into the transmitter as internal passageways that are transverse to the transmission path.

20. The system of claim 14 wherein the transmitter is constructed of quartz or sapphire.

21. The system of claim 14 further comprising:
the transmitter being an elongated transmitter having an axis, the transducer acoustically coupled to the transmitter so that sonic energy is transmitted through the transmitter along the axis; and
the internal passageways being oriented transverse to the axis.

22. The system of claim 14 wherein the internal passageways are substantially linear and substantially parallel to one another.

23. The system of claim 14 wherein the holes have a diameter in the range between 0.1 μm to 5.0 μm.

24. The system of claim 14 further comprising a depressor for generating bubbles in a fluid supplied to the internal passageways.

25. A system for processing substrates comprising:
a rotary support for supporting a substrate;
a transducer assembly comprising a transmitter and a transducer adapted to generate sonic energy, the transducer acoustically coupled to the transmitter;
the transducer assembly positioned so that so that a portion of the vibration transmitter is adjacent to and spaced from a surface of a substrate on the rotary support so that when a liquid is applied to the surface of the substrate, a film of the liquid couples the portion of the transmitter to the surface of the substrate;
a plurality of holes in an outer surface of the transmitter, the holes extending into the transmitter as internal passageways that are adapted to be operably connected to a source of fluid.

26. The system of claim 25 further comprising a depressor for generating bubbles in a fluid supplied to the internal passageways.

27. A transducer assembly comprising:
a transducer adapted to generate sonic energy;
a transmitter, the transducer acoustically coupled to the transmitter;
a plurality of holes in an outer surface of the transmitter, the holes extending into the transmitter as internal passageways that are adapted to be operably connected to a source of fluid.

28. The transducer assembly of claim 27 wherein the transducer assembly is adapted to be positioned so that so that a portion of the vibration transmitter is adjacent to and spaced from a surface of a rotating substrate so that when a liquid is applied to the surface of the rotating substrate, a film of the liquid couples the portion of the transmitter to the surface of the substrate;

29. The transducer assembly of claim 27 further comprising:
the transmitter being an elongated transmitter having an axis, the transducer acoustically coupled to the transmitter so that sonic energy is transmitted through the transmitter along the axis; and
the internal passageways being oriented transverse to the axis.

30. The transducer assembly of claim 27 wherein the sonic energy generated by the transducer is transmitted through the transmitter along a transmission path; and wherein the internal passageways pass transversely through the transmission path

31. A transducer assembly comprising:
a transducer adapted to generate sonic energy;
a transmitter, the transducer acoustically coupled to the transmitter; and
a plurality of internal passageways extending through the transmitter from holes in a first outer surface of the transmitter to holes in a second outer surface of the transmitter.

32. The transducer assembly of claim 31 wherein the sonic energy generated by the transducer is transmitted through the transmitter along a transmission path; and wherein the internal passageways pass transversely through the transmission path

33. A method of processing a substrate comprising:
supporting a substrate in a substantially horizontal orientation;
rotating the substrate;
providing a transducer assembly comprising a transducer adapted to generate sonic energy and a transmitter, the transducer acoustically coupled to the transmitter, and a plurality of holes in an outer surface of the transmitter, the holes extending into the transmitter as internal passageways that are adapted to supply a fluid;
applying a liquid to a surface of the substrate so as to form a meniscus of the liquid that couples a portion of the transmitter to the surface of the substrate;
applying sonic energy to the surface of the substrate via the transmitter; and
applying fluid into the meniscus via the holes in the outer surface of the transmitter.

34. The method of claim 33 wherein the fluid comprises a liquid and gas bubbles.

35. The method of claim 34 wherein the gas bubbles have a size between 0.3 μm to 3.0 μm in diameter.

37. The method of claim 33 wherein the holes have a diameter in a range between 0.1 μm to 5.0 μm.

38. The method of claim 33 wherein the transmitter overlay less than 100% of the surface of the wafer.

39. The method of claim 33 wherein the transmitter is an elongate transmitter.

40. A method of processing a substrate comprising:
a) supporting a substrate in a substantially horizontal orientation;
b) rotating the substrate;
c) providing a transducer assembly comprising a transmitter and a transducer adapted to generate sonic energy having a frequency, the transducer acoustically coupled to the transmitter;
d) applying sonic energy to the surface of the substrate via the transmitter, the sonic energy having a field; and
e) applying a liquid with bubbles to the surface of the substrate in the sonic energy field so that the bubbles dampen the sonic energy reaching the surface of the substrate, the bubbles having a predetermined size correlating to the frequency of the sonic energy.

41. The method of claim 40 wherein the frequency of the sonic energy is in a range between 600 kHz to 1100 KHz and the predetermined size of the bubbles is in a range of 0.3 μm to 3.0 μm in diameter.

42. The method of claim 40 wherein step e) further comprises flowing the liquid with bubbles through the transmitter and into a meniscus of liquid that couples a portion of the transmitter to the surface of the substrate.

43. The method of claim 42 wherein step e) further comprises flowing the liquid with bubbles through the transmitter via a plurality of internal passageways within the transmitter, the internal passageways sized to control the size of the bubbles to the predetermined size.

45. The method of claim 40 further comprising generating the bubbles within the liquid prior to application to the substrate.

46. The method of claim 45 wherein the bubble generation step comprises dissolving a gas into a liquid in a pressurized chamber so as to form a solution, flowing the solution out of the pressurized chamber, and depressurizing the solution prior to application to the surface of the substrate thereby generating the bubbles in the solution.

47. A system for processing a substrate comprising:
a rotary support for supporting a substrate;
a transducer assembly comprising a transmitter and a transducer adapted to generate sonic energy, the transducer acoustically coupled to the transmitter;
the transducer assembly positioned so that so that a portion of the vibration transmitter is adjacent to and spaced from a surface of a substrate on the rotary support so that when a liquid is applied to the surface of the substrate, a film of the liquid couples the portion of the transmitter to the surface of the substrate;
a plurality of holes in an outer surface of the transmitter, the holes extending into the transmitter as internal passageways that are adapted to be operably connected to a source of a solution comprising bubbles having a predetermined size.
